(19) United States
(12) Patent Application Publication
(10) Pub. No.: US 2009/0240401 A1
(43) Pub. Date: Sep. 24, 2009

(54) Trapping Prevention Guard and Method for Controlling a Motor-Driven Adjusting Device for an Adjusting Device

(75) Inventor: Thomas Rösch, Querfurt (DE)

Correspondence Address: KING & SPALDING, 1185 AVENUE OF THE AMERICAS, NEW YORK, NY, 10036-4003, US

(73) Assignee: BROSE FAHRZEUGTEILE GMBH & CO KOMMANDITGESELLSCAFT, COBURG, Coburg (DE)

(21) Appl. No.: 12/279,707

(22) PCT Filed: Feb. 15, 2007
(86) PCT No.: PCT/EP2007/001319

§ 371 Date: Oct. 30, 2008

(30) Foreign Application Priority Data
Feb. 17, 2006 (DE) 20 2006 002 525.1

(51) Int. Cl. G06F 7/00; G06F 19/00

(52) U.S. Cl. 701/49

(57) ABSTRACT

In order to draw a reliable conclusion about the existence of a jamming situation, in particular in a seat adjusting means, provision is made to distinguish between the following movement classes: a) running difficulty of the adjusting apparatus, b) jamming of an object, c) encountering an end stop, and d) sudden counter-reaction, with a decision criterion (c, c1, c₂, M₃) being derived from detected characteristic variables (u, i, n) of a motorized drive (2), and the current state of the adjusting apparatus being associated with one of the movement classes on the basis of said decision criterion.

The invention relates to a trapping prevention means and a method for controlling and regulating a motor-driven adjusting device, in particular a seat adjusting means in a motor vehicle.

A trapping prevention means is necessary in motor-driven seat adjusting devices in motor vehicles, for example in window winders, sliding roofs, sliding doors, tailgates etc, for safety reasons, in order to stop and possibly reverse the motorized drive when necessary, that is to say if an object or body part is trapped. Trapping prevention of this kind is in particular also desired in motorized seat adjustment means. Characteristic variables of the motorized drive are normally evaluated in order to determine whether trapping has occurred. Such characteristic variables are, for example, the motor voltage, the motor current or the rotation speed. The motor moment is normally determined from these characteristic variables, and an excess force is determined from said motor moment in turn. The excess force is given by the difference between the total force exerted by the motor and a total adjusting force which is required, in particular, to overcome the friction and to accelerate the adjusting device. However, it is difficult to determine the adjusting force since, for example, the friction can vary during the course of the adjustment process on account of areas with severe running difficulties. In addition, aging effects or else temperature influences can have a considerable influence on the friction. Temporarily varying acceleration forces are also taken into account when determining the excess force. Thus, for example, according to EP 1 310 030 B1, a large number of individual forces are added up at a summation point in order to determine the resulting excess force and an excess force or a trapping force is determined by comparison with the force currently exerted by the motor.

EP 1 299 782 B1 discloses a trapping prevention means in which the current profile of the force exerted by the motor over the adjustment path is compared with the profile of the force of a previous actuation process. However, if there is a relatively long period of time between the two actuation operations, the ambient conditions, for example temperature, may have significantly changed. Employing the force profile of a previous actuation process may therefore prove problematical in order to be able to use the previously measured force profile as the current profile of frictional force.

EP 0 714 052 B1 discloses a trapping prevention means for a side window or a sliding roof, in which the adjustment process is divided into equal time windows which lie in the region of 100 msec. In this case, this time window width should be selected on the basis of the trapping instance to be detected which occurs most slowly. In order to determine the excess force, the measured values of the current time point are compared with those of a reference time point which is at a distance of one window width from the current measurement time point and at which trapping has not occurred.

Reliable identification of trapping prevention in the event of seat adjustment is more complex than in relation to window winders or sliding roofs, in the case of which the glass pane moves toward a fixed stop.

The invention is based on the object of providing a simple trapping prevention means and also a straightforward method for reliably detecting a trapping instance, particularly in the case of seat adjustment.

According to the invention, the object is achieved by means of a trapping prevention means as claimed in patent claim 1. Accordingly, provision is made for a plurality of movement classes to be defined and for a distinction to be made between said movement classes in order to monitor for a trapping instance, and for a decision criterion to be derived from detected characteristic variables of the motorized drive, on the basis of which decision criterion the current state of the adjusting device is associated with one of the movement classes. In this case, the movement classes include, in addition to a running difficulty of the adjusting device, trapping of an object and run-up against an end stop, in particular, also the movement class of a sudden reaction and/or the movement class of a load movement of a load on the adjusting device.

The distinction between these movement classes is based on the consideration that, in the event of seat adjustment, particular situations can occur which have to be taken into account in the evaluation. Firstly, when a person is trapped, a so-called panic reaction can be expected as a sudden reaction. It is therefore assumed that, in particular situations and depending on the person concerned, said person will brace himself against the adjusting movement of the seat with all his force if he subjectively senses a dangerous situation.

As an alternative or in addition to the movement class of sudden reaction, the load movement of a load on the adjusting device is provided as a further movement class. This movement class applies when the person sitting on the seat moves during the adjustment process. On account of a change in load of this type, the current total load of the motor can be both increased and reduced. All the movement processes which are essential to the decision are covered by classification into this total of five movement classes in particular, and so a trapping instance can be reliably identified with only a low error rate.

The motor torque or a variable which is correlated with the motor torque is usually used as the decision criterion. This correlated variable is, for example, the motor rotation speed detected as a characteristic variable or else the motor current. The profile of the motor moment in the event of a panic reaction or a load movement differs from a normal trapping instance, in which only the seat moves toward an object. Distinguishing between these movement classes, in particular also identifying a movement class in relation to the sudden reaction and/or the load movement, therefore ensures that that special trapping situations which differ from the typical and normal trapping instance are also detected and identified as such.

In this case, a running difficulty of the adjusting device is understood to be the total friction, which has to be overcome by the drive motor, of the adjusting device, with this total friction usually varying over the adjustment path during the adjustment process and sometimes also including running difficulty peaks. Trapping of an object, in particular a person, is here understood to be the case in which the seat is moved toward a person who is either sitting on a back seat and is therefore pushed into the rear seat, or who is sitting on the seat to be adjusted and is moved, for example, toward the steering wheel or the dashboard, but without having to exert an excessive counter-force. That is to say, in this case, the normal trapping situation in which the person does not exhibit any pronounced reaction is assumed. Finally, the movement class of run-up against an end stop involves the situation in which the seat adjusting means moves into its front or rear end position in the event of a translatory adjustment or into the upright or inclined end position when the inclination of a backrest is adjusted. These end positions are usually defined by a mechanical end stop.

According to a preferred refinement, a spring model for the adjusting device is used as the basis for classification purposes and at least one spring constant is derived from the detected characteristic or input variables as the decision criterion. The use of a so-called spring model is based on the consideration that, on account of the compliance of the cushioning in a seat in the event of a trapping instance, said cushioning yields in the manner of a spring and therefore exerts a spring force against the adjusting movement. This is proportional to the path covered, with the proportionality factor being the spring constant. This spring constant is used as a decision criterion, that is to say the value or a variable derived from said value of the spring constants is used to make a decision as to which of the movement classes the current state of the adjusting device is to be associated with.

In this case, the spring constant is a variable derived from the total load of the motor. Therefore, a characteristic change in the total load of the motor, preferably a characteristic change in the motor moment, is used, in particular, as a decision criterion. The total load of the motor is therefore understood to be, in particular, the total torque exerted by the motor or the resulting total force exerted by the motor. Since other characteristic variables of the motor, for example the motor current or the motor rotation speed, are linked to the motor moment, it is furthermore also possible to use the motor current or, for example, the motor rotation speed as the decision criterion, in addition to the motor moment. The spring constant is preferably determined from the change in the motor moment or one of these characteristic variables.

In this case, the mathematical derivative of the total load is preferably used as the decision criterion. The derivative is generally understood to mean the change in the value of the total load in an interval, for example a time or distance interval. In this case, these intervals may be both infinitesimally small in the mathematical sense and also have predefined, fixed interval widths, so that the values for the total load have to be detected or determined only at defined sampling points. Since the total load is correlated to the force exerted by the motor, the spring constant or at least a variable which correlates with this spring constant can be directly given by the derivative of the total load.

According to a preferred development, the same value range for the decision criterion, but with different profiles of the decision criterion, is associated with the movement class of the load movement and the movement class of run-up against an end stop. This refinement is based on the knowledge that a load movement and run-up against an end stop in the spring model are represented by a spring constant of a comparable level, but the spring constant is highly time-dependent in the case of a load movement. In contrast, the mechanical stop can be described substantially by a constant spring constant. In other words, this refinement is based on the consideration that load influences can lead to a sharp increase in the total load of the motor in the short term but this is considerably reduced again after a short period of time, whereas the total load of the motor increasingly rises in the event of movement towards an end stop.

Different value ranges for the derivative are expediently associated with the individual movement classes. The lowermost value range is associated with the movement class a) the running difficulty, the following value range is associated with the movement class b) trapping of an object, the subsequent value range is associated with movement class c) run-up against an end stop, and the highest value range is finally associated with the movement class d) the sudden reaction. Identification of the respective movement classes and therefore identification of a trapping instance, specifically identification of the movement class b) trapping of an object and d) sudden reaction, is therefore ensured on the basis of these value ranges for the derivative, with delimitation with respect to further movement classes too.

According to an expedient development, the values or value ranges for the decision criterion, in particular the value ranges for the derivative and further threshold values or variables and values derived from the derivative, which are required for the classification operation, are determined with the aid of a measurement process on a physical model. In this case, the measurement results obtained are stored as values which can be used in the classification operation. This is done, for example, by the parameter values being stored in a table or a characteristic map and an unambiguous association of the individual values to the different movement classes being taken from this characteristic map. As an alternative, an association function can be provided on the basis of these values in the manner of a fuzzy logic. Instead of measurement on a physical model, a theoretical model or empirical values can be used as an alternative or in addition.

The profile of the spring constants or the derivative, that is to say the change in said spring constants, is preferably used for the association to the individual movement classes, in particular whether the movement class b), trapping of an object, is present. In this case, a trapping instance is identified when the value of the spring constants/derivative remains constant or possibly increases in a certain way. This is based on the consideration that, in the event of a normal trapping instance, that is to say without a panic or sudden reaction, the trapped person is expected to exert a certain counter-force. In the spring model which forms the basis, this is expressed by the spring constant (spring stiffness), which characterizes the compliance of the cushion, being superposed by a counter-force exerted by the person, so that the resulting spring constant increases. The check as to whether the value of the derivative increases therefore takes into account the expected behavior of a person in the event of a trapping instance.

In addition, identification of a trapping instance is preferably based on a predefined lower load threshold value, that is to say a predefined motor moment or a total force which is derived from this, being exceeded. The relevant decision criterion is determined only after this is exceeded. This is based on the consideration that an indication of a trapping instance is present only when there is a significant change in the total load, and that it is necessary to evaluate the profile of the total load with regard to the decision criterion and with regard to the presence of a trapping situation only in this case.

With regard to evaluation which is as simple as possible, at least and preferably exactly three load threshold values are defined in this case, with one value of the decision criterion in each case being determined and evaluated between two load threshold values in each case. Since the decision criterion is primarily considered to be the derivative of the profile of the total load, that is to say the change in the total load, meaningful evaluation without a great deal of outlay on computation is possible by means of this measure even on the basis of few measurement and detection points. In order to determine the derivative, the respective value pair at the three load threshold values in particular is, in this case, stored and suitably interpolated, for example linearly to the next value pair. The value pairs are formed from the respective load threshold value and an associated variable value, for example distance or time. This interpolation is then used to determine the value of the derivative for the respective interval of the variables, for example a specific time or distance interval, without problems.

In other to further make the decision as to whether trapping has occurred, provision is preferably additionally made for an upper load threshold value to be defined, this threshold having to be exceeded in order to conclude that trapping has occurred.

According to a preferred refinement, a nominal load which represents the total friction of the adjustment system is determined for the purpose of determining and defining the lower load threshold value which has to be exceeded in order to even begin the computational check as to whether trapping has occurred. In this case, the load threshold value is defined as a characteristic deviation of the currently detected total load from the nominal load. In order to determine the nominal load, the following process is followed in this case in particular: during a start phase in each case at the beginning of an actuation operation of the adjusting device, the total load detected for this time point is determined and stored as a nominal load. In this case, the load is, in particular, the motor moment, the force exerted by the motor or else a variable which is correlated with this, for example the detected and, in particular, averaged motor rotation speed or the detected motor current.

According to the invention, the object is also achieved by a method having the features of patent claim 18. The advantages and preferred refinements given with regard to the trapping prevention means can therefore correspondingly also be transferred to the method.

Some of the individual features and combinations of features in the patent claims, possibly with the addition of further features or combinations of features from the description, are also independent of the features of independent patent claims 1 and 2. We reserve the right to submit partial applications which do not or do not fully contain the features of claim 1 or 2.

Exemplary embodiments of the invention are explained in greater detail below with reference to the figures, in which:

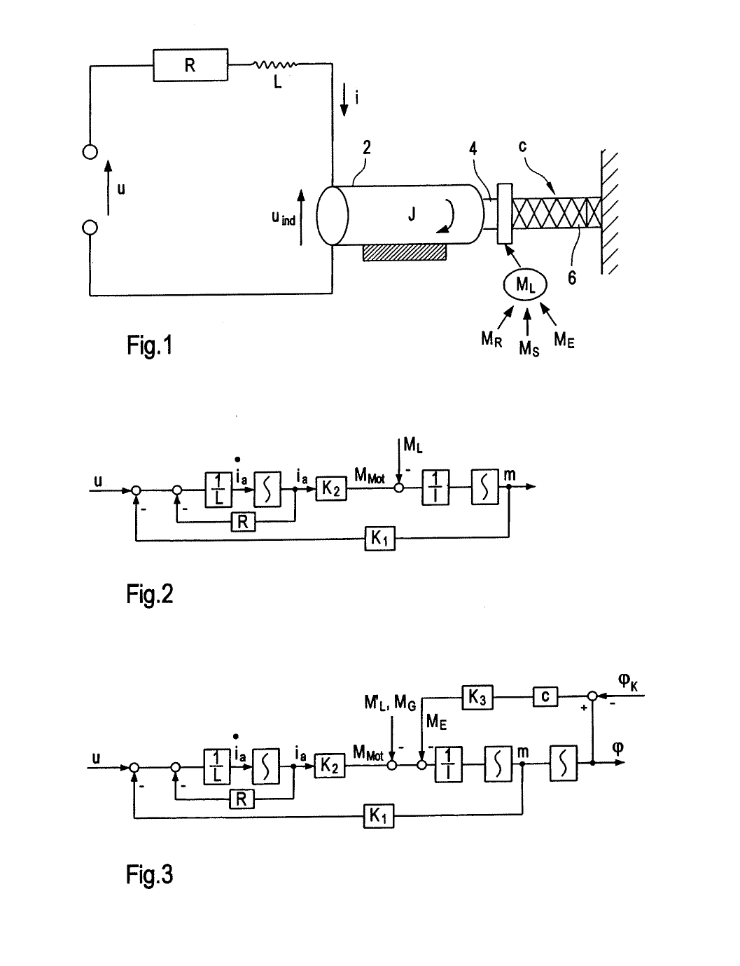

FIG. 1 shows a schematic and simplified illustration of a physical conceptual model of an adjusting device, in particular of a seat adjusting means,

FIG. 2 shows a schematic and simplified illustration of a control loop for a first mathematical model for describing the individual processes in the adjusting device,

FIG. 3 shows a schematic and simplified illustration of a second control loop for a second mathematical model for describing the individual processes in the adjusting device, taking into account a trapping instance,

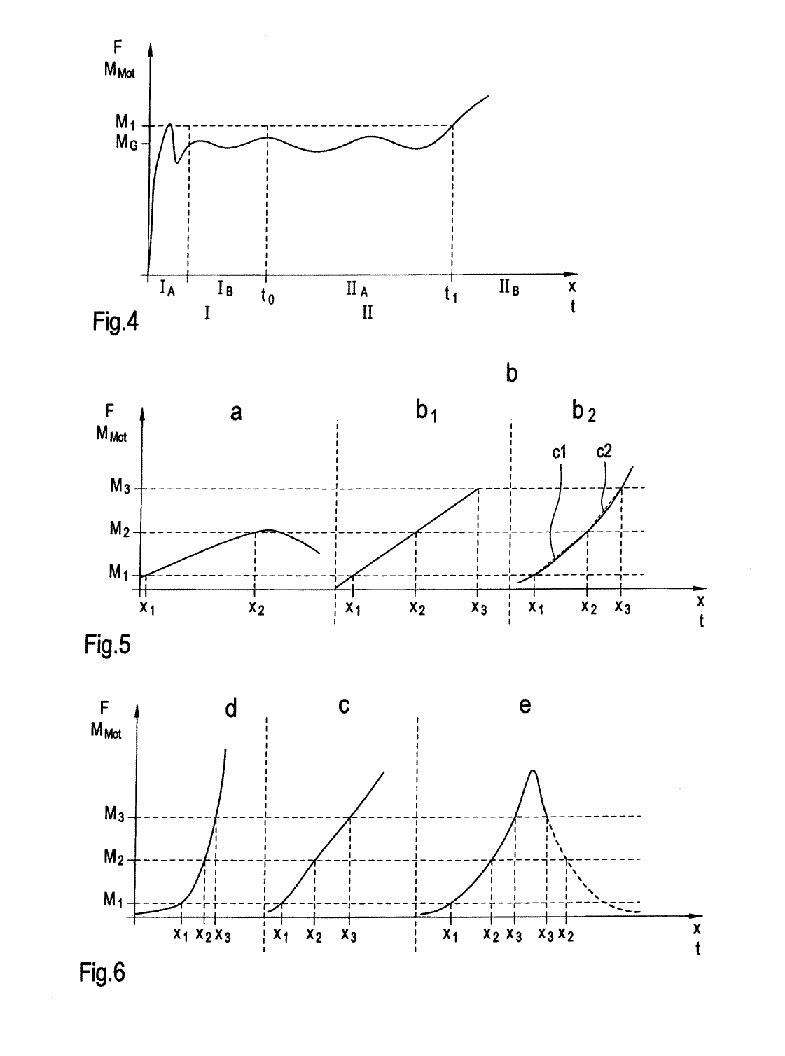

FIG. 4 shows a schematic and simplified illustration of the profile of the motor torque or the motor force with respect to travel or time,

FIGS. 5 and 6 show schematic and simplified illustrations of force or torque profiles for different movement classes which occur during the adjustment movement and

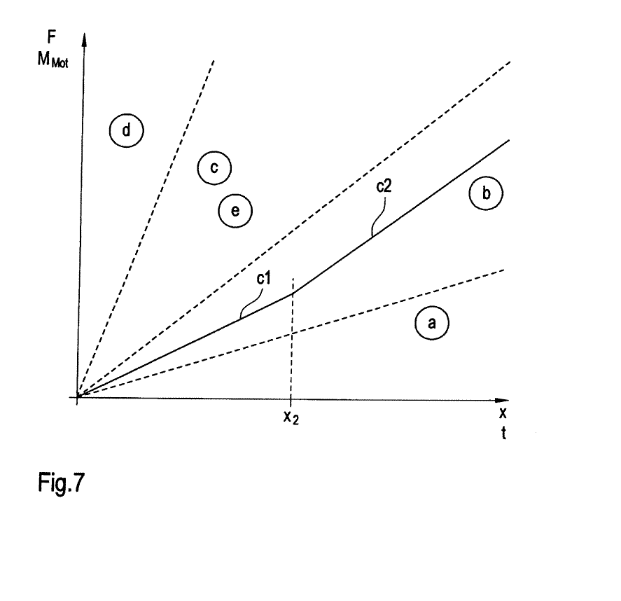

FIG. 7 shows a schematic and simplified illustration of a force/travel graph in which the individual movement classes are associated with different regions.

The method for reliable detection of a trapping instance explained below with reference to the figures applies in particular to use in a motor-driven seat adjusting means in the motor vehicle sector. A device of this type has an adjusting mechanism which comprises a seat support which can usually be longitudinally adjusted in guide rails which are slightly inclined with respect to the horizontal. A backrest whose inclination can be adjusted is also attached to the seat support. In this case, the rotation point of the backrest is arranged such that it is somewhat spaced apart from the guide rails. Furthermore, the adjusting device comprises a respective drive motor both for translatory adjustment in the longitudinal direction of the seat support and for inclination adjustment of the backrest. These motors are usually a DC motor or a rotation speed-controlled DC motor.

When seats are automatically adjusted, there is a risk of a person being trapped in the seat to be adjusted or else between the seat to be adjusted and a back seat. A trapping instance of this kind leads to a high motor torque and therefore correlates to a higher force expended by the motor. This total torque generated by the motor is also generally called the total load in the present case. Identification of a trapping instance is problematical particularly in the case of seat adjustment of this type since the force to be additionally applied by the motor does not necessarily exhibit an abrupt increase in the event of trapping on account of the soft seat cushion.

The method described below is suitable, in particular, for a seat adjusting means, but can, in principle, be applied to other adjusting devices, for example window winders, sliding doors, trunk lids, sliding roofs, etc. too.

The computational and mathematical treatment of an adjusting device of this kind with the aid of a control device is explained in greater detail below with reference to FIGS. 1 to 3. In this case, FIG. 1 shows a physical conceptual model of an adjusting device of this type. According to this physical model, the motor voltage u is applied to the motor 2 during operation and a motor current i flows. The electrical circuit has a non-reactive resistor R and an inductor L. A back e.m.f. u_{ind} is induced during operation. On account of the motor current i, the motor exerts a motor moment M_{Mot} and drives a shaft 4 at a rotation speed n. The adjusting mechanism of the adjusting device is coupled to the shaft 4, this being represented by the moment of inertia J. In addition, a load moment M_{L} is exerted by the adjusting mechanism, this load moment counteracting the motor moment M_{Mot}. The load moment M_{L} is made up of a plurality of moment components, for example a moment of friction M_{R} which is exerted on account of the friction of the adjusting device and can additionally be superimposed with a moment of running difficulty M_{S}. In the event of trapping, a trapping moment M_{E} is additionally added to the load moment M_{L}. This trapping moment M_{E} has to be determined in order to be able to reliably identify trapping prevention. The problem here is that the further components of the load moment M_{L} are variable. It is particularly difficult to identify a trapping instance in the case of trapping prevention for a seat adjusting means since the trapping force increases only slowly on account of the compliance of the seat cushion and a distinction can be made, for example, from a local running difficulty only with great difficulty.

In the event of trapping, a spring model is assumed in order to physically and mathematically describe in a simple model the real processes when a person is trapped between the seat and a further seat or the dashboard. In the physical model shown in FIG. 1, this is expressed by the trapping moment M_{E} which contributes to the load moment M_{L} being characterized as a spring moment of a spring 6 which counteracts the motor moment M_{Mot}. This spring 6 is further characterized by a spring stiffness which is represented by means of a spring constant.

Taking this physical model as a basis, the following equation 1 is given for the motor voltage u:

u=R·i+Ldi/dt+u_{ind} Equation 1

This can be differentiated to give the equation 1′ for the variable di/dt:

di/dt=1/L(u−R·i−K₁n) Equation 1′

with the following relationship, according to which the induced voltage u_{ind} is proportional to the rotation speed n and the proportionality factor is K₁, having been taken into account here:

u_{ind}=K₁n Equation 2

Furthermore, the motor moment M_{Mot} is proportional to the motor current i multiplied by a proportionality constant K₂:

M_{Mot}=K₂i Equation 3

For the right-hand side of the physical model according to FIG. 1, the following equation, according to which the difference between the motor moment M_{Mot} and the load moment M_{L} is proportional to the change in rotation speed n, with the proportionality factor being the moment of inertia J, can be established for the torques:

M_{Mot}−M_{L}=Jdn/dt Equation 4

The moment of inertia J is actually made up of several components, in particular the moment of inertia of the motor and that of the mechanical parts of the seat. Since very large transmission ratios are generally provided for motorized seat adjusting means, the proportion of the total moment of inertia of the mechanical parts can be ignored and it is sufficient to take into account the moment of inertia of the motor for the calculation. The following equation, according to which the trapping moment M_{E} is proportional to the spring force F_{F}, with the proportionality factor K₃ being a weighting parameter which takes into account the geometry of the adjusting mechanism, can be derived from the spring model for the trapping moment M_{E}. In this case, the weighting parameter takes into account, for example, the lever length, the lever transmission ratio or the position of the adjusting mechanism. Information about the areas of risk, that is to say, for example, the distances between the seats which, in particular, are also dependent on the body size, are additionally incorporated in the weighting parameter. The spring force F_{F} is in turn proportional to the rotation angle φ−φ_{K} covered, with the proportionality factor being the spring constant c. In this case, φ_{K} is the rotation angle at the time point at the beginning of the trapping instance, that is to say when contact is made for the first time between the seat to be adjusted and the trapped person.

M_{E}=K₃F_{F}=K₃c(φ−φ_{K}) Equation 5

A mathematical model or a corresponding calculation algorithm, which can be represented by the control loop illustrated in FIG. 2 if the spring model which represents the trapping instance is still not taken into account, can be derived from this physical model. This control loop substantially represents the relationships according to equations 1 to 4. Accordingly, the motor voltage u, as actuating signal, creates a specific rotation speed n. A change in the motor current i leads to a change in the voltage drop across the non-reactive resistor R. Equally, a change in the load moment M_{L} leads to a change in the rotation speed and therefore to a change in the induced back e.m.f. These two voltage components act on the motor voltage u again, so that a control loop is formed overall.

By taking into account the supplementary spring model, a second mathematical model can be derived, with the aid of which the actual situation can be checked for the presence of a trapping instance. This second model can be represented by a control loop according to FIG. 3. This control loop is extended compared to the control loop according to FIG. 2 by means of the spring model, as is represented by equation 5.

The rotation angle φ is given by integration of the rotation speed n. The trapping moment M_{E} is built up on account of the spring constant c. The load moment M_{L} determined last by means of the first mathematical model according to FIG. 2 is, as a constant variable from the first model, adopted as an input variable M_{L}′ for the second model according to FIG. 3. The input variable M_{L}′ corresponds to a nominal moment M_{G} which characterizes the total friction of the system. All of the variables incorporated in this second model, specifically the inductor L, the resistor R, the constants K₁ to K₃ and the moment of inertia J of the motor, are known or can be determined and the rotation speed and therefore the rotation angle can be measured. The single unknown factor is the spring constant c which can thus be determined with the aid of a suitable algorithm on the basis of the second mathematical model.

The variables L, R and K₁ and K₂ are motor-specific characteristic variables which are known when using a specific type of motor or at least can be determined by experiments. The moment of inertia J and the constant K₃ are variables which characterize the adjusting mechanism or the interaction of the motor with the adjusting mechanism, which variables can be and also are likewise determined, in particular, by experiments on reference models. In this case, the constant K₃ is determined separately for each type of adjusting device. In this case, the values of the parameter K₃ are measured and stored, particularly with the aid of measurements on an actual model of the adjusting device. It should be noted here that, in particular, the weighting parameter K₃ which represents the mechanism of the seat adjusting means is dependent on other variables, for example angle of inclination of the backrest or current longitudinal position of the seat. Therefore, a table of values or a characteristic map for the parameter K₃ is created overall and stored in a memory of the control device. The respectively valid parameter values are then taken from this table of values or characteristic map in each case depending on the current position of the seat, and adopted in the calculation for the first or second model. In this case, the values of these parameters can also be processed using fuzzy logic.

FIG. 4 illustrates a typical profile of the motor moment M_{Mot} with respect to the adjustment path x or else with respect to time t. The force F exerted by the motor can also be plotted instead of the motor moment M_{Mot}. It is not absolutely necessary to determine and to evaluate the motor moment. It is sufficient to determine or additionally use and evaluate a variable which correlates to the exerted force F. The correlated variable is, for example, the detected rotation speed n.

In the method, a distinction is made between a start phase I and a monitoring phase II. The start phase I is divided into two sub-phases I_{A} and I_{B}, with the sub-phase I_{A} representing a start-up phase of the motor 2 during which the motor 2 is adjusted to a specific, substantially constant motor moment M_{Mot}. The motor moment M_{Mot} remains at this level if there are no frictional changes, running difficulties or trapping situations. The second sub-phase I_{B} serves to determine a nominal moment M_{G}. This corresponds to the motor moment M_{Mot} which is output by the motor 2 during this sub-phase I_{B} and is also called the total moment or total load. The nominal moment M_{G} is determined, in particular, by calculating the average value of the values for the motor moment M_{Mot} over the second sub-phase. As an alternative to this, the average value is calculated over the entire start phase I and the start-up effects are ignored.

The start phase I becomes the monitoring phase II at a time point t₀. In this case, the time point t₀ is formed such that the adjusting device has covered a predefined adjustment path up until this time point. The value for the nominal moment M_{G} determined during the start phase I is first stored as a comparison value for the monitoring phase II. During the monitoring phase II, a significant or characteristic deviation is defined as a difference from the nominal moment M_{G} and a limit value which is called lower load value M₁ is stored. The profile of the motor moment M_{Mot} is now monitored in order to determine whether this lower load limit value M₁ is exceeded. In this case, the averaged profile of the rotation speed n is used as a criterion for the profile of the motor moment M_{Mot}.

In this case, both the value for the nominal moment M_{G} and, with it, the lower load value M₁ are preferably adapted during the adjustment process. Different frictional values and local running difficulties usually occur, specifically over the adjustment path, so that the motor moment M_{Mot} varies and, for example, also increases continuously over a relatively long adjustment path. If the nominal moment M_{G} were not adapted, there would be a risk of the load value M₁ being exceeded, this being a triggering criterion for checking whether trapping has occurred. In this case, the nominal moment M_{G} is adapted, for example, by moving average value calculation over a predefined time window or else by means of continued average value calculation, starting from time point to.

If the load value M₁ is exceeded, this is judged to be an indication of a possible trapping instance. At this time point, a changeover is made from the first mathematical model to the second mathematical model and the spring model is now taken into consideration for the calculation. When the changeover is made to the second model, at least one variable which is still determined with the first model is adopted here as an input variable for the second model. This variable is, for example, the value for the last actual nominal moment M_{G}, since this represents the sum of all the moments acting on the drive, excluding the trapping moment M_{E}.

The changeover to the second mathematical model is therefore made at time point t₁, at which the load value M₁ is exceeded. Therefore, the monitoring phase II is also divided into two sub-phases II_{A} and II_{B}, with the first mathematical model being used for monitoring purposes during the first sub-phase II_{A} and the second mathematical model being used during the sub-phase II_{B}.

The second mathematical model is now used to check whether trapping has actually occurred. This is explained in greater detail below with reference to FIGS. 5 to 7. If it is established during this checking operation that trapping has occurred, the motor 2 is automatically stopped and possibly reversed. If it is established that trapping has not occurred, a changeover is then made to the first mathematical model again and the sub-phase II_{A} of the monitoring phase II is continued.

When checking a seat adjusting means for a trapping instance, the profile of the motor moment M_{Mot} is examined to determine which of the following movement classes are present:
a) running difficulty of the adjusting device,
b) trapping of an object, with a distinction being made here between two trapping situations b1, b2,
c) run-up against an end stop,
d) sudden reaction (panic reaction) and
e) load movement.

The characteristic profiles for these movement classes of the motor moment M_{Mot} are illustrated in FIGS. 5 and 6.

As can be seen from the individual curve sections in FIGS. 5 and 6, the movement class a) for running difficulty is distinguished by a slow increase in moment. High torques are not usually reached in this case. In contrast to this, the curve profile for the movement class for the trapping instance b) is distinguished by a somewhat steeper increase. In this case, the trapping situations can occur, in principle, of a virtually immovable object being trapped. Taking the spring model, which represents the physical reality very well, as a basis, this means a uniform, linear increase in the force exerted by the motor 2 and therefore in its motor moment M_{Mot}. This corresponds to the curve section according to b₁. However, it is usually expected that the person exerts a certain counter-force. This is illustrated by the curve profile according to b₂, according to which the increase in moment is progressive and not linear. The movement class c) is distinguished by a sharper increase in force compared to movement class b), since here the seat mechanism moves against a mechanical stop. The increase is usually linear in this case since the mechanical stop is characterized by at least a constant spring rate or spring constant c and the force therefore builds up linearly proportionally to the distance covered. In contrast to this, in the case of a load movement (movement class e)), that is to say, for example, movement of the person on the seat during the seat adjustment process, an increase in force which is similar to the amount of movement can be identified, but with the profile of the increase in force no longer being linear like in the event of run-up against the mechanical stop. Finally, a further movement class d), specifically that of a panic reaction, is defined. It is assumed here that, in certain situations, the person responds to the risk of being trapped with a sudden reaction. This is generally expressed by the said person bracing himself against the adjusting movement with all his force. This creates a very steep increase in force. A strictly linear profile is not to be expected here either.

In the spring model which forms the basis, the increase in force or motor moment M_{Mot} corresponds to the gradient or derivative, and therefore to the spring constants c, for evaluation of these different situations. Therefore, the spring constant c, which can be obtained by means of the derivative, is used as the decision criterion as the critical criterion for classifying the currently measured profile of the motor moment M_{Mot}. In addition, further decision criteria, which have to be satisfied, are provided for unambiguous association. The term “derivative” is to be understood very broadly here. It is essential for characteristic variables for the profile of the respective motor moment M_{Mot} to be determined, from which characteristic variables conclusions can be drawn as to which movement classes a) to e) are present.

In the exemplary embodiment, an average load value M₂ and a maximum load value M₃ are defined in addition to the lower load value M₁ in order to identify the different movement classes. If the respective load value M₁ to M₃ is reached, the associated adjustment path x₁ to x₃ (or else the associated time point t) is stored and value pairs (M₁, x₁), (M₂, x₂) and (M₃, x₃) are respectively formed. As an alternative to this, it is also possible to predefine fixed travel points during the sub-phase II_{B} and to determine the respectively current motor moment M_{Mot} at these travel points.

A value for the gradient c₁, c₂ is then determined in each case from the value pairs, in particular by simple linear interpolation or another mathematical interpolation. This is indicated in FIG. 5 in relation to movement class b2. The computational outlay is very low due to the evaluation of only three discrete value pairs. As an alternative to this, it is of course possible to determine the derivative continuously.

Some movement classes a) to e) differ additionally or sometimes only by virtue of the profile of the increase. By determining three value pairs, two intervals are used for evaluation purposes, so that it is possible to identify whether the increase in force is increasing, remaining the same or possibly even decreasing.

In addition to the decision criterion of the derivative (gradient c1, c2), a further decision criterion used is the maximum load value M₃ being exceeded. Therefore, a trapping instance is identified only when the derivative moves in a predetermined value range and at the same time the maximum load value M₃ is exceeded. With regard to the derivative, the decision value used is not only the absolute value but also the profile of the absolute value.

As can be seen from comparison of FIGS. 5 and 6, it is of critical importance for the movement class for the panic reaction d) to be taken into account as such. The movement classes b) and d) represent trapping situations, but the movement classes c) and e), specifically run-up against an end stop and load movement, lie between these two trapping situations. However, it is undesirable to switch off or reverse the motor, particularly in the case of load movement. Therefore, high decision reliability for identifying a trapping instance, without having to accept losses in comfort, is possible only by checking the curve profile for such a panic reaction.

The derivative is of particular importance for associating the currently measured profile with the individual movement classes a) to e). For association in terms of which value of the derivative or which profile of the derivative is to be associated with which of the movement classes a) to e), it is expedient—similarly to in the case of the weighting factor K₃—to store the individual values or profiles of the derivative in a table or in a characteristic map from which association with the individual movement classes can be performed directly or with the aid of a fuzzy logic, taking into account further boundary parameters. In this case, the table or the characteristic map is preferably likewise determined in the manner of a calibration process on the basis of a specific physical model, or empirical values are employed.

FIG. 7 illustrates a force/travel graph which is derived from such a characteristic map and in which the individual regions which are to be associated with the movement classes a)-e) are separated from one another by dashed lines. Furthermore, a force profile with a progressive increase in force in the event of trapping is plotted, by way of example, with the determined gradient values c1, c2.

### LIST OF REFERENCE SYMBOLS

| | | | |
|---|---|---|---|
| 2 | Motor | c | Spring constant |
| 4 | Shaft | K₁, K₂ | Proportionality |
| | | | constants |
| 6 | Spring | K₃ | Weighting |
| | | | parameter |
| | | F_{F} | Spring force |
| u | Motor voltage | φ | Rotation angle |
| R | Resistor | φ_{K} | Rotation angle |
| | | | at contact time |
| | | | point |
| L | Inductor | t | Time |
| i | Motor current | x | Adjustment path |
| u_{ind} | Induced voltage | M₁ | Lower load |
| | | | value |
| M_{Mot} | Motor moment | M₂ | Average load |
| | | | value |
| n | Rotation speed | M₃ | Maximum load |
| | | | value |
| J | Moment of | c1, c2 | Gradient |
| | inertia | | |
| M_{L} | Load moment | I | Start phase |
| M_{R} | Moment of | I_{A} | Initial phase |
| | friction | | |
| M_{S} | Moment of running | I_{B} | Second sub- |
| | difficulty | | phase |
| M_{E} | Moment of | II | Monitoring |
| | trapping | | phase |
| M_{G} | Nominal moment | II_{A}, II_{B} | Sub-phases of |
| | | | the monitoring |
| | | | phase |

1. A trapping prevention means for an adjusting device, in particular a seat adjusting means of a motor vehicle, having a motorized drive (2) and a control unit which is designed in such a way that a distinction is made between at least the movement classes a) running difficulty of the adjusting device, b) trapping of an object, c) run-up against an end stop of the adjusting device and d) sudden reaction in order to monitor for a trapping instance, with a decision criterion (c, c1, c2, M₃) being derived from detected characteristic variables (u, i, n) of the motorized drive (2), on the basis of which decision criterion the current state of the adjusting device is associated with one of the movement classes.

2. A trapping prevention means for an adjusting device, in particular a seat adjusting means of a motor vehicle, having a motorized drive (2) and a control unit which is designed in such a way that a distinction is made between at least the movement classes a) running difficulty of the adjusting device, b) trapping of an object, c) run-up against an end stop of the adjusting device and e) load movement of a load on the adjusting device in order to monitor for a trapping instance, with a decision criterion (c, c1, c2, M₃) being derived from detected characteristic variables (u, i, n) of the motorized drive (2), on the basis of which the current state of the adjusting device is associated with one of the movement classes.

3. The trapping prevention means as claimed in claims 1 and 2, in which a distinction is made between the movement classes a) to e).

4. The trapping prevention means as claimed in one of the preceding claims, in which a spring model is used as the basis for classification purposes and at least one spring constant (c) is derived from the detected characteristic variables as the decision criterion.

5. The trapping prevention means as claimed in one of the preceding claims, in which a characteristic change in the total load of the motor, in particular a characteristic change in the motor moment (M_{Mot}) is used as the decision criterion (c, c1, c2).

6. The trapping prevention means as claimed in claim 5, in which at least one spring constant (c, c1, c2) is determined from the total load of the motor, from the motor moment (M_{Mot}).

7. The trapping prevention means as claimed in claim 5 or 6, in which the mathematical derivative of the total load (M_{Mot}) is used as the decision criterion (c1, c2).

8. The trapping prevention means as claimed in one of claims 2 to 7, in which the same value range, but different profiles of the decision criterion (c1, c2), are associated with the movement class e) of the load movement and the movement class c) of run-up against an end stop.

9. The trapping prevention means as claimed in one of claims 6 to 8, in which the spring constant (c1, c2) is associated with the movement classes in the order a-b-c-d as the value increases.

10. The trapping prevention means as claimed in one of the preceding claims, in which, in order to determine values for the decision criterion (c1, c2, M₃) which are required for the classification operation, a measurement is performed on a physical model and the measurement results are stored as values which can be used in the classification operation.

11. The trapping prevention means as claimed in one of claims 6 to 10, in which the profile of the spring constant (c1, c2) is used for association with one of the movement classes, in particular for movement class b) of trapping.

12. The trapping prevention means as claimed in claim 11, in which a trapping instance is identified when association is made with movement class b) and when a maximum value of the spring constant (c1, c2) is exceeded.

13. The trapping prevention means as claimed in one of the preceding claims, in which the decision criterion (c, c1, c2) is first determined after a lower load threshold value (M₁) is exceeded.

14. The trapping prevention means as claimed in one of the preceding claims, in which at least three load threshold values (M₁-M₃) are defined and a value of the decision criterion is determined and evaluated between two load threshold values in each case.

15. The trapping prevention means as claimed in one of the preceding claims, in which the value pair comprising the load value (M₁-M₃) and a variable value of a variable (t, x), as a function of which the load is determined, is stored when a load threshold value (M₁-M₃) is reached, and the value for the decision criterion is determined with the aid of interpolation between the value pairs.

16. The trapping prevention means as claimed in one of the preceding claims, in which an upper load threshold value (M₃) is defined, and a trapping instance is identified only when the upper load threshold value (M₃) is exceeded and when association is made with the movement class b).

17. The trapping prevention means as claimed in one of claims 4 to 15, in which the total load (M_{Mot}) is firstly determined during a start phase (I) in each case at the beginning of an actuation operation of the adjusting device and stored as the nominal load (M_{G}) of the adjusting device, and in which the decision criterion (c, c1, c2) is first determined when there is a characteristic deviation between the nominal load (M_{G}) and the total load (M_{Mot}) which varies during the actuation operation of the adjusting device.
